(19) United States
(12) Patent Application Publication
(10) Pub. No.: US 2022/0221620 A1
(43) Pub. Date: Jul. 14, 2022

(54) EYEGLASS LENS PROTECTOR SYSTEM

(71) Applicant: Ian Contreras, Moorpark, CA (US)

(72) Inventor: Ian Contreras, Moorpark, CA (US)

(21) Appl. No.: 17/706,591

(22) Filed: Mar. 29, 2022

Related U.S. Application Data
(63) Continuation-in-part of application No. 15/925,750, filed on Mar. 19, 2018, now abandoned.
(60) Provisional application No. 62/473,118, filed on Mar. 17, 2017.

(51) Int. Cl. G02B 1/14; G02C 11/00

(52) U.S. Cl. CPC G02B 1/14; G02C 11/00

(57) ABSTRACT

An eyeglass lens protector system including a transparent protective film having a first-layer, a second-layer, and a third-layer. The first-layer and the third-layer are removeable from the second-layer. The second-layer is configured to removeably adhere to a lens-surface and provide a protective barrier to protect against smudging, scratching, and breaking of the lens-surface. The transparent protective film may also be applied to electronic device screens or other surfaces.

### CROSS-REFERENCE TO RELATED APPLICATION

The present application is a Continuation-in-Part of U. S. Non-provisional Patent application Ser. No. 15/925,750, filed 19 Mar. 2018, pending, which is incorporated by reference herein in its entirety. The present application is related to and claims priority to U.S. Provisional Patent Application No. 62/473,118, filed Mar. 17, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### FIELD OF THE INVENTION

The present invention relates generally to the field of protective coatings and more specifically relates to a protective film to be applied to a surface.

### DESCRIPTION OF RELATED ART

Eyeglasses or spectacles, are devices consisting of lenses which are mounted in a frame and worn on the bridge of the nose so that the lenses are in front of a person's eyes. Glasses are typically used for vision correction. Eyeglasses are prone to debris and may need to be cleaned several times a day in order for the lenses to remain clear. Eyeglasses are a requirement for some individuals, whether they are near- or far-sighted. The glasses are an expensive investment and must be protected for extensive use. Smudges, scratches, fingerprints, and other inconveniences are common, and people may spend an exorbitant amount of time cleaning their glasses. If the smudges are not removed, visibility may be impaired. A suitable solution is desired.

U.S. Pub. No. 2017/0219742 to Matthew Baker relates to a curved lens protector. The described curved lens protector includes a curved lens protector which can include a transparent body having a self-supporting x-y axis curve with a concave inner surface and a convex outer surface opposite the inner surface. The transparent body can have an outer boundary of a predetermined shape to substantially match and fit with respect to an inner boundary of a lens holder portion of a predetermined lens frame. The transparent body can be configured for attachment to a predetermined curved lens without the use of an adhesive.

### BRIEF SUMMARY

An eyeglass lens protector system that has a transparent protective film is disclosed. The film has a top layer (sometimes comprising PET) with a top surface, a bottom surface, and a first adhesive portion on the bottom surface of the top layer. The film has a second layer (sometimes comprising PET). This layer is a lens protecting layer having a top surface, a bottom surface, and a second adhesive portion on the bottom surface of the lens protecting layer. And the film also has a third layer (sometimes comprising PET). This layer is a release layer having a top surface and a bottom surface.

The top surface of the top layer contacts an adhesive. For example, the lens protecting layer is disposed on the release layer. The top surface of the release layer contacts the second adhesive layer and a bottom surface that does not contact an adhesive. In some exemplars, the protective film has three configurations.

In the first configuration, the first adhesive layer directly adheres the top layer to the lens protecting layer, and the second adhesive layer directly adheres the release layer to the lens protecting layer. In a second configuration, the first adhesive layer directly adheres to the top layer to the lens protecting layer. Next, the second adhesive layer directly adheres a portion of the release layer to the lens protecting layer. Finally, in a third configuration, the first adhesive layer directly adheres the top layer to the lens protecting layer, and the release layer is separate from the lens protecting layer.

In some exemplars, the transparent protective film has a fourth configuration in which the first adhesive layer directly adheres the top layer to the lens protecting layer, and the second adhesive layer removably adheres the lens protecting layer to a surface of the eyeglass lens.

In some exemplars, transparent protective film has a fifth configuration in which the top layer is separate from the lens protecting layer.

In some exemplars, the lens protecting layer contains a clear TPU film. In some exemplars, the transparent protective film comprises a shape similar to the lens. Sometimes, the transparent protective film is flexible and configured to contour to an outer portion of the lens surface. Depending on the version of the film, the lens surface is curved or can be flat.

In some exemplars, the transparent protective film has an outer boundary extending within and to an inner boundary of a lens border. In some exemplars, the lens protecting layer is abrasion and scratch resistant. In some versions, the lens protecting layer provides a shock-resistant layer preventing screen and lens breakage.

In some versions, the transparent protective film further comprises a pull tab, which can be part of the top layer or can be disposed on the top layer.

In some versions, the system also has a smoothing application tool, a cleaning cloth, and a set of instructions.

### BRIEF DESCRIPTION OF THE DRAWINGS

The figures illustrate embodiments and methods of use for the present disclosure, an eyeglass lens protector system, constructed and operative according to the teachings of the present disclosure.

FIG. 1 is a perspective view of the eyeglass lens protector system during an ‘in-use’ condition, according to an embodiment of the disclosure.

FIG. 2 is a perspective view of the eyeglass lens protector system of FIG. 1, according to an embodiment of the present disclosure.

FIG. 3 is a perspective view of the eyeglass lens protector system of FIG. 1, according to an embodiment of the present disclosure.

FIG. 4 is a perspective view of the eyeglass lens protector system of FIG. 1, according to an embodiment of the present disclosure.

FIG. 5 is a flow diagram illustrating a method of use for the eyeglass lens protector system, according to an embodiment of the present disclosure.

The various embodiments of the present invention will be described with the appended drawings, wherein like designations denote like elements.

### DETAILED DESCRIPTION

As discussed above, embodiments of the present disclosure relate to a protective coating and more particularly to an eyeglass lens protector system as used to improve the protection of eyewear.

Generally, the present invention provides eyeglass wearers with a protective covering for their lenses. It prevents fingerprints, scratches, and other damage to eyeglass lenses upon installation. It utilizes a thin, film-like product which adheres directly overtop eyeglass lenses for protection. It installs conveniently on any size, shape, make, and model of eyeglass lenses. The present invention offers a simple-to-install, inexpensive, and convenient method of keeping eyeglass lenses fully protected for an extended period of time. Eyeglass lens protector system may be applied over eyeglass lenses for effective protection from scratches, smudges, and more.

The eyeglass lens protector system comprises of a thin layer of film designed to adhere to virtually any type of eyeglass lenses. The eyeglass lens protector system is intended to fit the lens type to prevent any overlapping or accidental removal. Users can simply peel the film from its packaging and apply it directly over the eyeglass lenses. The film should easily adhere to the lenses for a perfect fit. The film can be applied and removed at any time. Upon removal, the film leaves the lenses in perfect, usable condition without worry of impaired visibility. When removed, the film does not leave residue from the adhesive. Eyeglass lens protector system can be constructed using plastic and other suitable materials.

The present invention may be used on cameras, watches, mobile devices, or other screens for protection. In a preferred embodiment, the eyeglass lens protector system preferably comprises a thickness of 0.15 mm, a haze maximum of 1.5%, a hardness of 3H, a light transmittance minimum of 92%, and an adhesion power of 130 g/inch. Other specifications may be used. The HD film may prevent oxidation and corrosion.

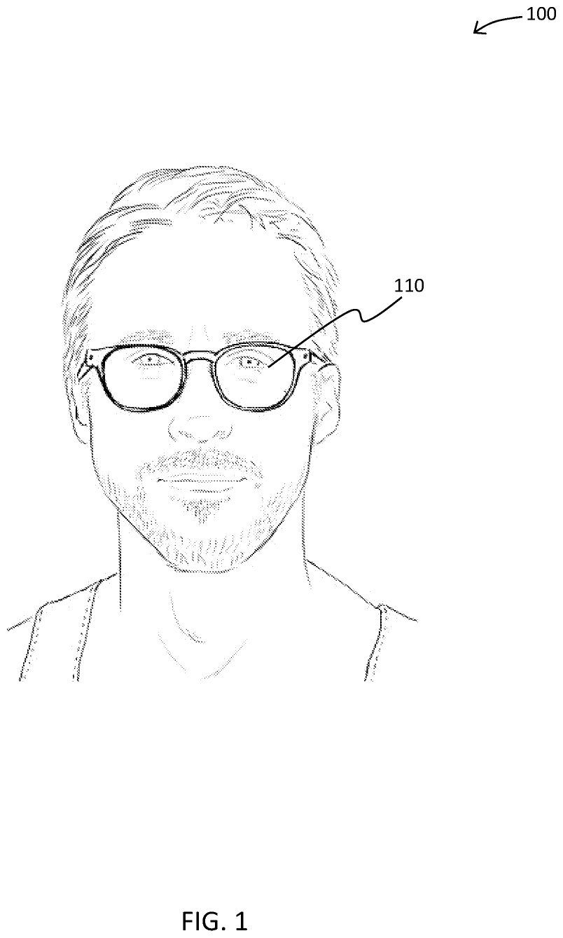

Referring now more specifically to the drawings by numerals of reference, there is shown in FIGS. 1-4, various views of an eyeglass lens protector system 100. FIG. 1 shows an eyeglass lens protector system 100 during an ‘in-use’ condition 150, according to an embodiment of the present disclosure. As illustrated, the eyeglass lens protector system 100 may include a transparent protective film 110 having a first-layer 120, a second-layer 130, and a third-layer 140. The transparent protective film 110 comprises the first-layer 120, the-second-layer 130, and the third-layer 140 in a respective series, together forming a thickness. The first-layer 120 and the third-layer 140 are removeable from the second-layer 130. The second-layer 130 is configured to removeably adhere to a lens-surface 10. The transparent protective film 110 comprises a substantially similar shape as a lens having the lens-surface 10. The transparent protective film 110 when applied provides a protective barrier to protect against smudging and scratching of the lens-surface 10.

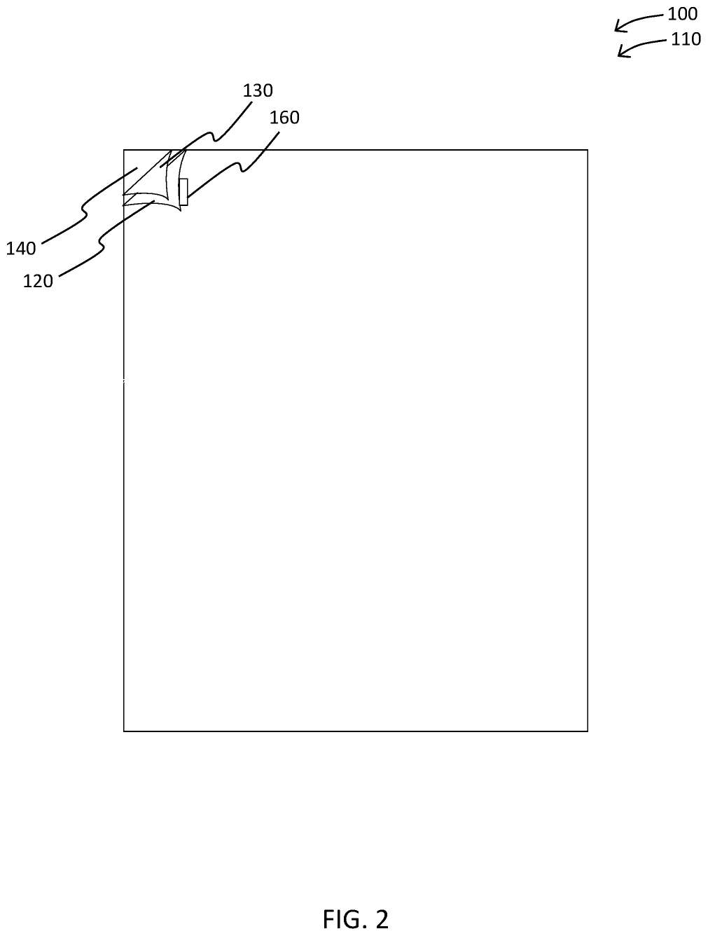

FIG. 2 shows a perspective view of the eyeglass lens protector system 100 of FIG. 1, according to an embodiment of the present disclosure. As above, the eyeglass lens protector system 100 may include the transparent protective film 110 having the first-layer 120, the second-layer 130, and the third-layer 140. The transparent protective film 110 is flexible and configured to contour an outer portion of the lens-surface 10. The lens-surface 10 may be curved or flat. The transparent protective film 110 is further configured to be applied to a screen of a mobile device, camera or other screen. The transparent protective film 110 has an outer boundary extending within and to an inner boundary of a lens-border. The first-layer 120 comprises a yellow PET protective film providing a protective layer. The second-layer 130 comprises a clear TPU film with silicone-adhesive. The third-layer 140 comprises a clear PET release liner.

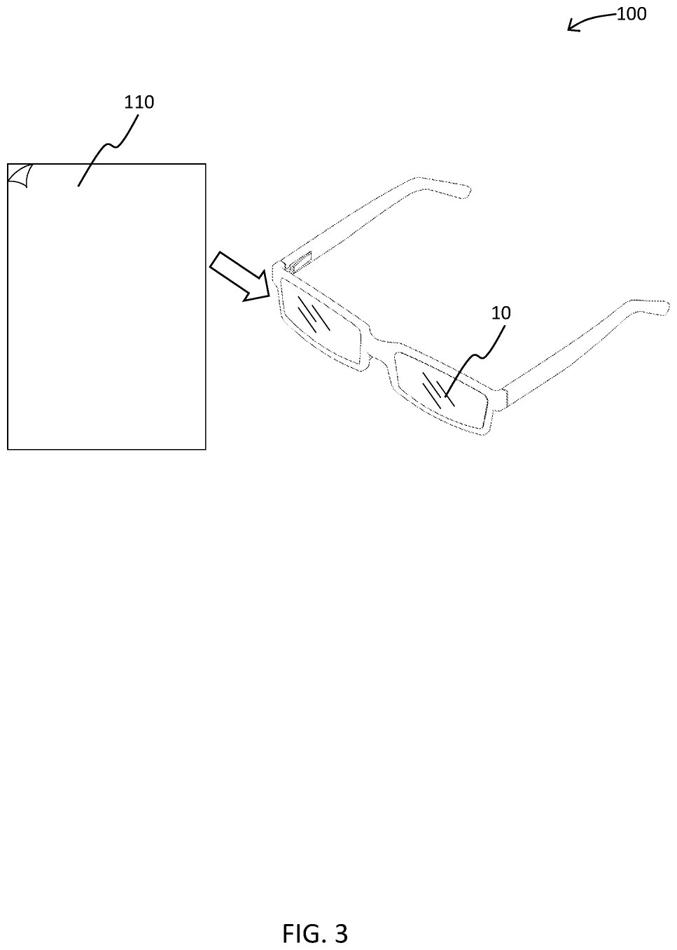

Referring now to FIG. 3 showing a perspective view of the eyeglass lens protector system 100 of FIG. 1, according to an embodiment of the present disclosure. As above, the eyeglass lens protector system 100 may include the transparent protective film 110. The transparent protective film 110 is abrasion and scratch resistant. The transparent protective film 110 comprises a thickness of approximately 0.3 mm. The transparent protective film 110 further comprises a pull tab. The pull tab 160 is on a removeable layer of the transparent protective film 110.

The removeable layer is the first-layer 120. The transparent protective film 110 provides a shock resistant layer preventing screen and lens breakage.

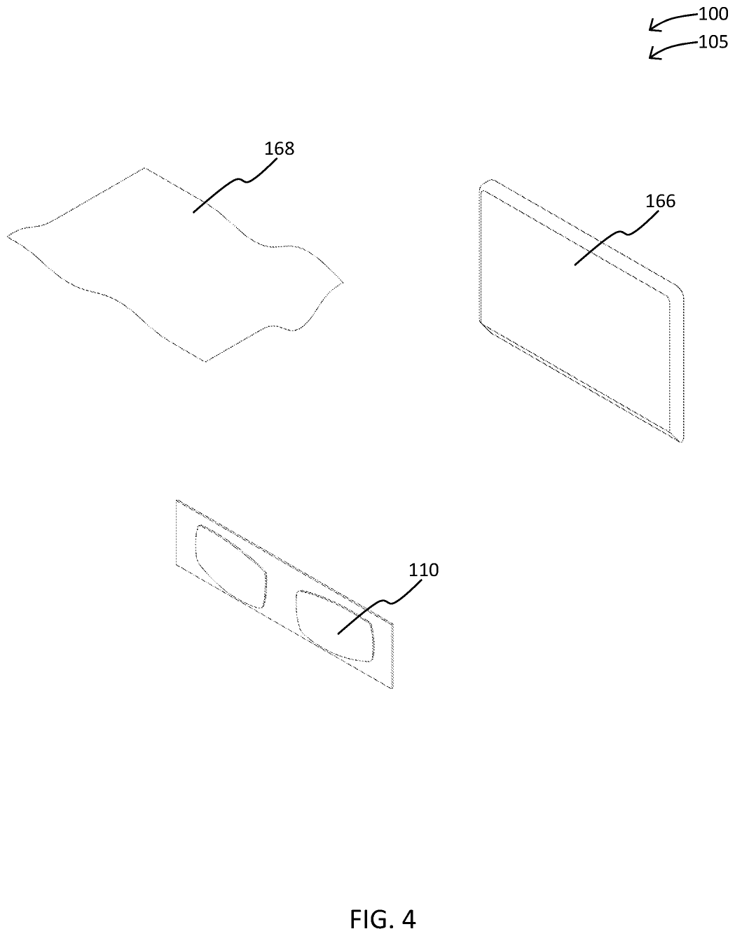

FIG. 4 is a perspective view of the eyeglass lens protector system 100 of FIG. 1, according to an embodiment of the present disclosure. According to one embodiment, the applying eyeglass lens protector system 100 may be arranged as a kit. In particular, the applying eyeglass lens protector system 100 may further include a set of instructions; at least one transparent protective film 110; a smoothing application tool 166; and a cleaning cloth 168. The instructions may detail functional relationships in relation to the structure of the applying eyeglass lens protector system 100 such that the applying eyeglass lens protector system 100 can be used, maintained, or the like, in a preferred manner.

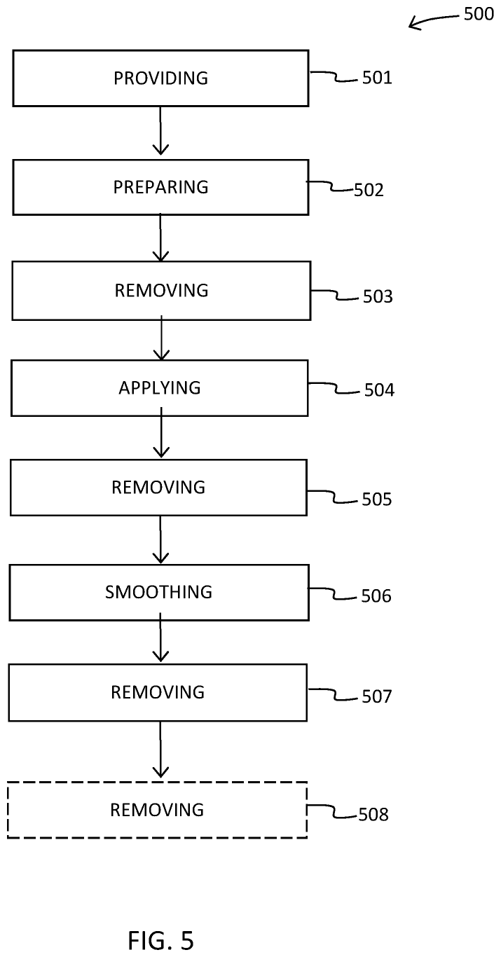

FIG. 5 is a flow diagram illustrating a method for applying eyeglass lens protector system 500, according to an embodiment of the present disclosure. In particular, the method for applying eyeglass lens protector system 500 may include one or more components or features of the eyeglass lens protector system 100 as described above. As illustrated, the method for applying eyeglass lens protector system 500 may include the steps of: step one 501, providing a transparent protective film 110 having a first-layer 120, a second-layer 130, and a third-layer 140; step two 502, preparing and cleaning a lens-surface 10; removing a first-half of the third-layer 140; step three 503, applying the second-layer 130 to the lens-surface; step four 504, removing a second-half of the third layer 140; step five 505, smoothing the transparent protective film 110 to remove bubbles; step six 506, removing the first-layer 120; and step seven 507, removing the transparent protective film 110 from the lens-surface 10.

It should be noted that step seven 507 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for applying eyeglass lens protector system, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. An eyeglass lens protector system comprising:
a transparent protective film having
a top layer having a top surface, a bottom surface, and a first adhesive portion on the bottom surface of the top layer;
a lens protecting layer having a top surface, a bottom surface, and a second adhesive portion on the bottom surface of the lens protecting layer; and
a release layer having a top surface and a bottom surface,
wherein less than all of the top surface of the top layer contacts an adhesive.

2. The system of claim 1, wherein the lens protecting layer is disposed on the release layer and the top surface of the release layer contacts the second adhesive layer and a bottom surface that does not contact an adhesive.

3. The system of claim 2, wherein the protective film has three configurations:
in a first configuration
the first adhesive layer directly adheres the top layer to the lens protecting layer and
the second adhesive layer directly adheres the release layer to the lens protecting layer
in a second configuration
the first adhesive layer directly adheres the top layer to the lens protecting layer and
the second adhesive layer directly adheres a portion of the release layer to the lens protecting layer, and
in a third configuration
the first adhesive layer directly adheres the top layer to the lens protecting layer and
the release layer is separate from the lens protecting layer.

4. The system of claim 3, wherein the transparent protective film further comprises a fourth configuration having
the first adhesive layer directly adheres the top layer to the lens protecting layer and
the second adhesive layer removably adheres the lens protecting layer to a surface of the eyeglass lens.

5. The system of claim 4, wherein the transparent protective film further comprises a fifth configuration, wherein the top layer is separate from the lens protecting layer.

6. The system of claim 5, wherein the lens protecting layer comprises a clear TPU film.

7. The system of claim 6, wherein the lens protecting layer comprises a shape similar to the lens.

8. The system of claim 7, wherein the lens protecting layer is flexible and configured to contour to an outer portion of the lens surface.

9. The system of claim 8, wherein the lens surface is curved.

10. The system of claim 9, wherein the lens surface is flat.

11. The system of claim 10, wherein the lens protecting layer has an outer boundary extending within and to an inner boundary of a lens border.

12. The system of claim 11, wherein the top layer comprises a PET film that protects the lens protecting layer.

13. The system of claim 12, wherein the release layer comprises a clear PET release liner.

14. The system of claim 13, wherein the lens protecting layer is abrasion and scratch resistant.

15. The system of claim 14, wherein the transparent protective film further comprises a pull tab.

16. The system of claim 15, wherein the pull tab is disposed on the top layer.

17. The system of claim 16, wherein the lens protecting layer provides a shock resistant layer preventing screen and lens breakage.

18. The system of claim 17, further comprising:
a smoothing application tool;
a cleaning cloth; and
a set of instructions.
